(19) United States
(12) Patent Application Publication
(10) Pub. No.: US 2008/0235215 A1
(43) Pub. Date: Sep. 25, 2008

(54) DATA SEARCH METHOD, RECORDING MEDIUM RECORDING PROGRAM, AND APPARATUS

(75) Inventor: Hiroyuki Suzuki, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/050,640

(22) Filed: Mar. 18, 2008

(30) Foreign Application Priority Data
Mar. 22, 2007 (JP) 2007-074294

(51) Int. Cl. G06F 17/30

(52) U.S. Cl. 707/5; 707/E17.014

(57) ABSTRACT

A data search method causes a computer to search data stored in a search target apparatus based on keywords entered as search conditions.

The computer performs a management step of detecting data attached as a file to an E-mail transmitted/received via a network in a predetermined zone; and associating information identifying the attached file and an attachment count of the file being attached to E-mails before being recorded in a table for management.

When a plurality of pieces of data matching the search conditions are extracted by the search step, the computer determines a priority of each piece of extracted data by reading the attachment count of the extracted data attached to E-mails by referring to the table and reflecting the attachment count in the priority.

### TECHNICAL FIELD

The present invention relates to a method of searching data stored in a magnetic storage apparatus or a memory of a search target apparatus using a computer, a recording medium recording a program for realizing such a method, and an apparatus having such a function, and in particular, relates to improvement of means for giving priority to a plurality of pieces of data extracted by a search.

For example, when searching data on the Internet, search engines are frequently used. A search engine searches index data extracted from data on a server based on input keywords showing search conditions entered by a client, gives priority (ranking) to data matching the search conditions, returns the matching data and priorities to the client, and has the matching data displayed on a screen of the client according to priority.

Four methods shown below have been known as means for calculating scores of priority:

### 1) Based on Data Content

For example, scores of priority are calculated based on appearance frequencies, appearance positions, and distribution information of search keywords in data.

### 2) Based on Data Attribute Information

For example, priority scores are calculated based on the file type and creator name.

### 3) Based on Links of a Web Page

For example, scores of priority are calculated based on link frequencies from other Web pages and reliability and importance of link source Web pages. This is based on a value judgment that a page linked from many pages has important information.

### 4) Based on Reference Frequencies in a Display List of Search Results

The search engine records which data in the display list of search results is referenced and data with higher reference frequencies will have higher scores.

Particularly in an Internet search, methods 3) and 4) are regarded as important because results are displayed in the order expected by a search requester.

However, in an organization (such as a company), calculation of priorities according to the method of 3) has not been able to secure enough reliability because there are not so many pieces of data explicitly having links to other data. Namely, while data on the Internet is predominantly HTML data in the Web page format and links to other pages are frequently used, data in an organization (such as a company) is often stored as independent document files (for example, Word®, Excel®, PowerPoint® and the like of Microsoft®), instead of the Web page format, and has no data link. Thus, priorities cannot be calculated according to the method of 3).

Moreover, in an organization (such as a company), data is often referenced directly on the server without using a search engine. Thus, according to the method of 4), records of reference frequencies on the search engine are insufficient and calculation accuracy of priorities has not been improved.

### SUMMARY

A data search method causes a computer to search data stored in a search target apparatus based on keywords entered as search conditions.

A management step detects data attached as a file to an E-mail transmitted/received via a network in a predetermined zone and associates information identifying the attached file and an attachment count of the file being attached to E-mails before being recorded in a table for management.

When a plurality of pieces of data matching the search conditions are extracted by the search step, a priority determination step determines a priority of each piece of extracted data by reading the attachment count of the extracted data attached to E-mails by referring to the table and reflecting the attachment count in the priority.

### BRIEF DESCRIPTION OF THE DRAWINGS

FIG. 1 is a block diagram showing a computer network including a data search apparatus according to an embodiment of the present invention;

FIG. 2 is a flow chart showing contents of calculation period setting processing by the data search apparatus in FIG. 1;

FIG. 3 is a flow chart showing contents of attached file registration processing by the data search apparatus in FIG. 1;

FIG. 4A a flow chart showing contents of a first half of data collection processing by the data search apparatus in FIG. 1;

FIG. 4B a flow chart showing contents of a second half of data collection processing by the data search apparatus in FIG. 1;

FIG. 5 is a flowchart showing contents of search processing by the data search apparatus in FIG. 1;

FIG. 6 is an illustration exemplifying a hash value table generated by the data search apparatus in FIG. 1;

FIG. 7 is an illustration exemplifying an index table generated by the data search apparatus in FIG. 1; and

FIG. 8 is an illustration exemplifying a pathname entry table generated by the data search apparatus in FIG. 1.

### DETAILED DESCRIPTION OF THE EMBODIMENT

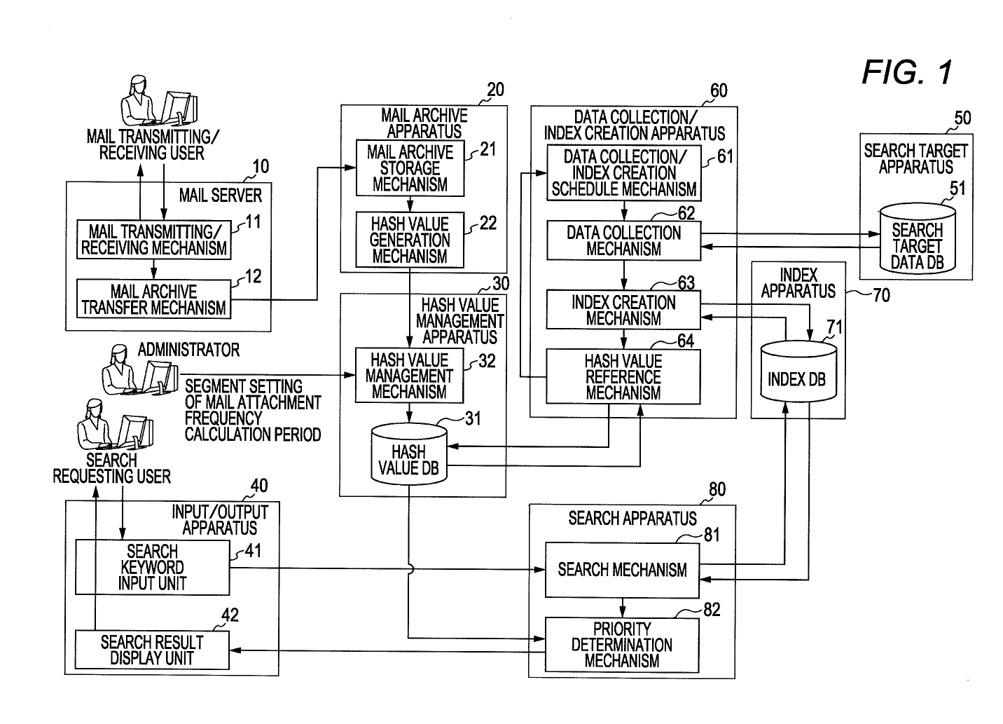

An embodiment of a data search apparatus will be described. FIG. 1 is a block diagram conceptually showing the configuration of a computer network including the data search apparatus in the embodiment. The network includes a mail server 10, a mail archive apparatus 20, a hash value management apparatus 30, an input/output apparatus 40, a search target apparatus 50, a data collection/index creation apparatus 60, an index storage apparatus 70, and a search apparatus 80. The mail server 10 controls transmission/reception of E-mails (hereinafter simply referred to as mail) after being accessed by mail transmitting/receiving users. The mail archive apparatus 20 stores mail archives, and the hash value management apparatus 30 manages hash values used for matching data files. The input/output apparatus 40 is operated by search requesting users. The search target apparatus 50 stores data files to be searched. The data collection/index creation apparatus 60 collects data stored in the search target apparatus 50 and creates indexes for searching. The index storage apparatus 70 stores indexes controlled and created by administrators. The search apparatus 80 searches files based on index information stored in the index storage apparatus 70 when a search request is made from the input/output apparatus 40.

The mail server 10 exchanges mail with other mail servers and transmits received mail stored on the mail server 10 to user clients in response to requests from mail transmitting/receiving users. Alternatively, the mail server 10 comprises a mail transmitting/receiving mechanism 11 for transmitting transmission mail transmitted from a user client to other mail servers and a mail archive transfer mechanism 12 for transferring mail to the mail archive apparatus 20 for subsequent audit objectives.

The mail archive apparatus 20 includes a mail archive storage mechanism 21 for storing transferred mail as archives and a hash value generation mechanism 22 which, when transferred mail messages have attached files, determines hash values by converting the attached files using a hash function. When a user attaches a file to a piece of mail, the user frequently changes the filename and it is bothersome to write a pathname separately in the mail and thus, the filename and pathname are not usually written. Therefore, when it is determined whether or not an attached file matches data in a search target apparatus, the filename and pathname cannot be used. Thus, the content of a file is coded as a hash value using a hash function and whether or not file contents match is determined by comparing hash values.

Since the hash function is used to convert files to determine whether or not an attached file and files stored in a search target apparatus match, a hash function whose uniqueness depending on the file content can be relied on must be used. Here, for example, SHA (Secure Hash Algorithm) −256 is used, but any function whose reliability can be secured may also be used.

The hash value management apparatus 30 has a hash value DB (database) 31 in which a hash value table is stored and a hash value management mechanism 32 for managing the hash value table. The administrator makes settings to the hash value management mechanism 32 of the hash value management apparatus 30 in order to manage frequencies of data attached to mail in a segmented time sequence.

The input/output apparatus 40 comprises a search keyword input unit 41 and a search result display unit 42. The search keyword input unit 41 sends keywords entered by a search requesting user to the search apparatus 80 to cause the search apparatus 80 to do a search. The search result display unit 42 displays search results returned by the search apparatus 80 to the search requesting user.

The search target apparatus 50 is provided with a search target data DB (database) 51 in which data files to be searched are stored.

The data collection/index creation apparatus 60 includes a data collection/index creation schedule mechanism 61, a data collection mechanism 62, an index creation mechanism 63, and a hash value reference mechanism 64. The data collection/index creation schedule mechanism 61 manages schedules of data collection and index creation. The data collection mechanism 62 collects data stored in the search target data DB 51 according to the schedules. The index creation mechanism 63 creates indexes by publicly known methods such as morphological analysis and N-Gram after compiling collected data in text format. The hash value reference mechanism 64 references a hash value table after determining a hash value for each file of collected data.

The index storage apparatus 70 has an index DB 71 in which created indexes are stored.

The search apparatus 80 includes a search mechanism 81 and a priority determination mechanism 82. The search mechanism 81 searches the index DB 71 based on keywords sent from the search keyword input unit 41 of the input/output apparatus 40. The priority determination mechanism 82 determines, for a plurality of data files extracted as a result of searching, priorities in consideration of the attachment count recorded in the hash value table.

Incidentally, among the above components, the input/output apparatus 40 and the search mechanism 81 of the search apparatus 80 correspond to the search means. The mail archive apparatus 20, the hash value management apparatus 30, and the data collection/index creation apparatus 60 correspond to the management apparatus, and the search mechanism 81 of the search apparatus 80 corresponds to the priority determination means.

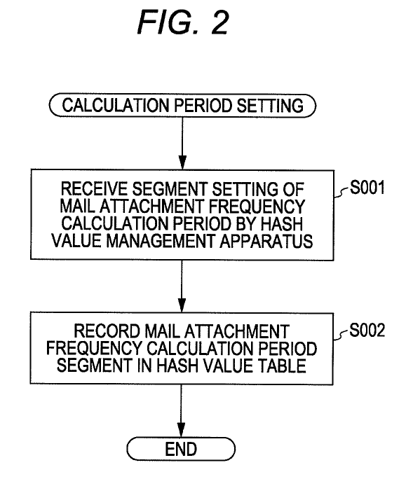

An operation of a network of the embodiment configured as described above will be described based on flow charts shown in FIG. 2 and subsequent figures. Here, it is assumed that three data files shown in Table 1 below are stored in a search target data DB.

TABLE 1

| Document's pathname | Contents |
|---|---|
| ¥¥Diraa¥Doc1.txt | For searching of company's documents, a search |
| | using a search function is . . . |
| ¥¥Dirbb¥Doc2.doc | A search system of images searches . . . |
| ¥¥Dircc¥Doc3.pdf | To search system program sources, . . . |

In calculation period setting processing shown in FIG. 2, the administrator accesses the hash value management mechanism 32 of the hash value management apparatus 30. In the calculation period setting processing, the administrator sets segments of periods in which frequencies of data files attached to mail, that is, numbers of times of attachment are totaled in the first step S001. In the next step S002, period segments that have been set are recorded in a hash value table.

Here, for example, it is assumed that the calculation period setting processing divides one month into three periods. The attachment count from the 1st to 10th, that from the 11th to 20th, and that from the 21st to 31st are each totaled. This period setting is made, for example, for files whose frequencies change depending on periods in a month so that processing in which such frequency changes are reflected and the level of priority is raised in relevant periods and lowered in other periods or the like.

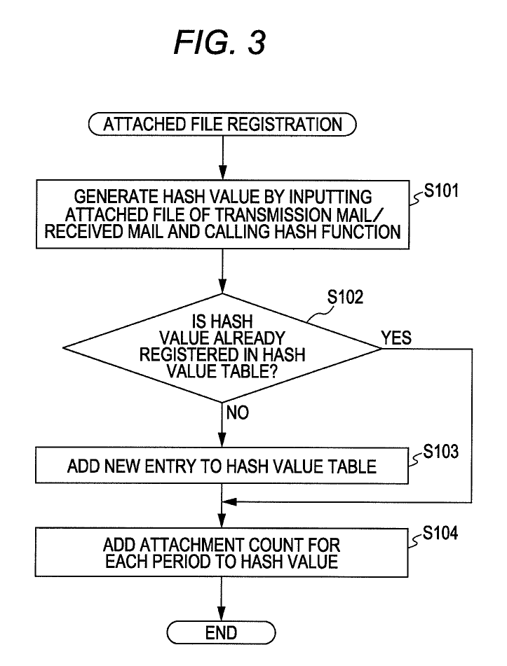

Each time a mail message is transmitted to or received from other servers, the mail server 10 transmits a copy of the mail to the mail archive apparatus 20. If any file is attached to the transmitted mail, the mail archive apparatus 20 determines a hash value of the file and updates the hash value table. FIG. 3 is a flow chart showing an operation between the mail archive apparatus 20 and the hash value management apparatus 30 on this occasion.

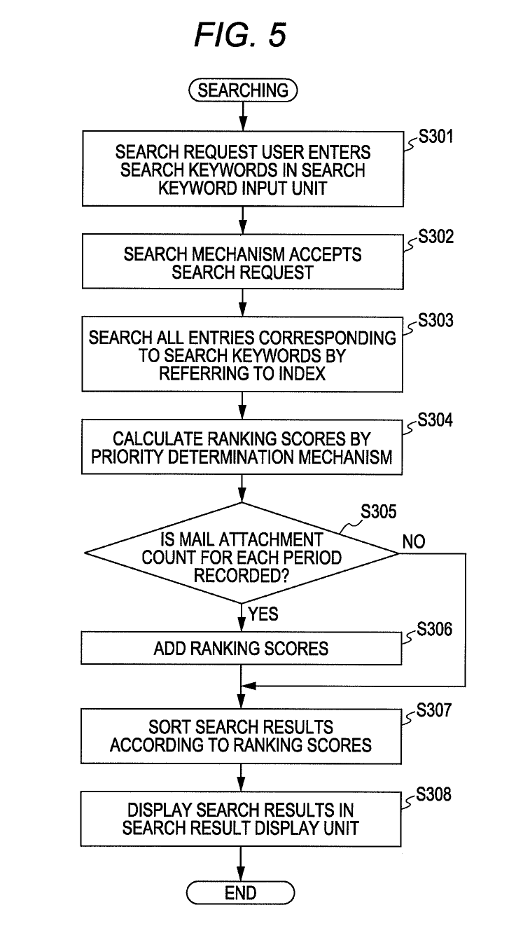

In attached file registration processing in FIG. 3, a hash function is called with a transmission mail or a received mail as an input to generate a hash value of the attached file in the first step S101. The attached file registration processing determines in the next step S102 whether or not the generated hash value is stored in the hash value table, that is, whether or not the attached file is already registered in the hash value table. The hash value table stores, as shown in FIG. 6, a plurality of records (three records in this example) and each record has five fields of Entry, Hash value, and attachment counts of three periods.

If the current hash value is not registered in the hash value table, the attached file registration processing adds in S103 a new record after creating a new entry to the hash value table before proceeding to S104. If the current hash value is registered in the hash value table, the attached file registration processing skips S103 to proceed to S104.

The attached file registration processing increments the attachment count of the period corresponding to the current hash value by one count in S104 based on the date/time when the attached mail was transmitted/received before completing the attached file registration processing. If the file is attached to a mail dated the 5th, for example, the value of the “Attachment count of 1st to 10th” field of the record having the relevant hash value is incremented by one.

The attached file registration processing is performed each time a mail message to which a file is attached is transmitted/received, and circumstances of which file is attached in which period are sequentially recorded in the hash value table.

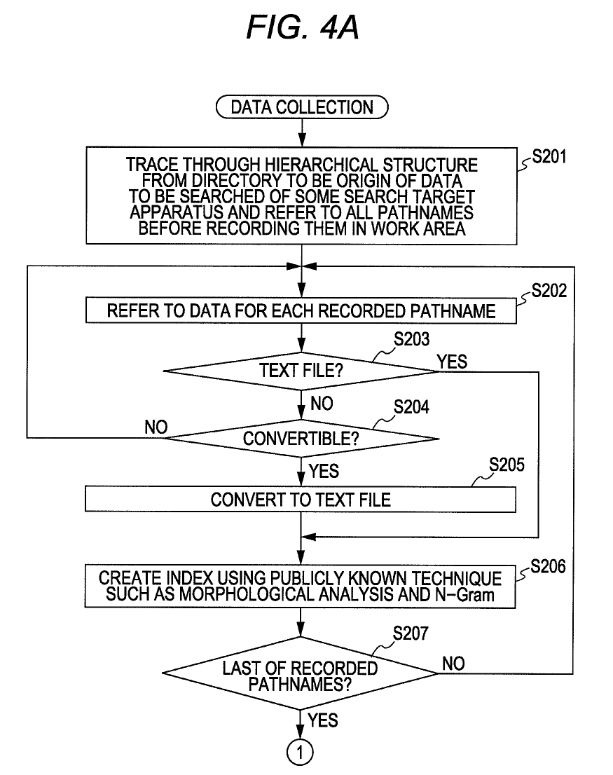

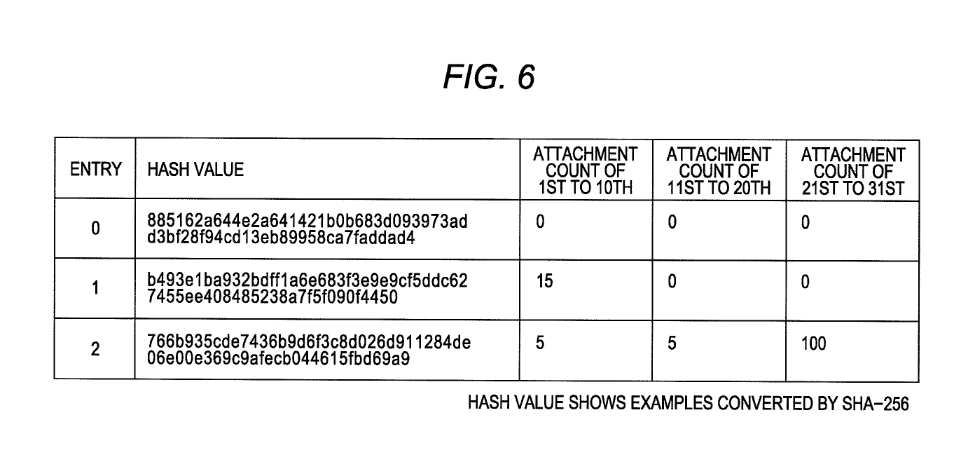

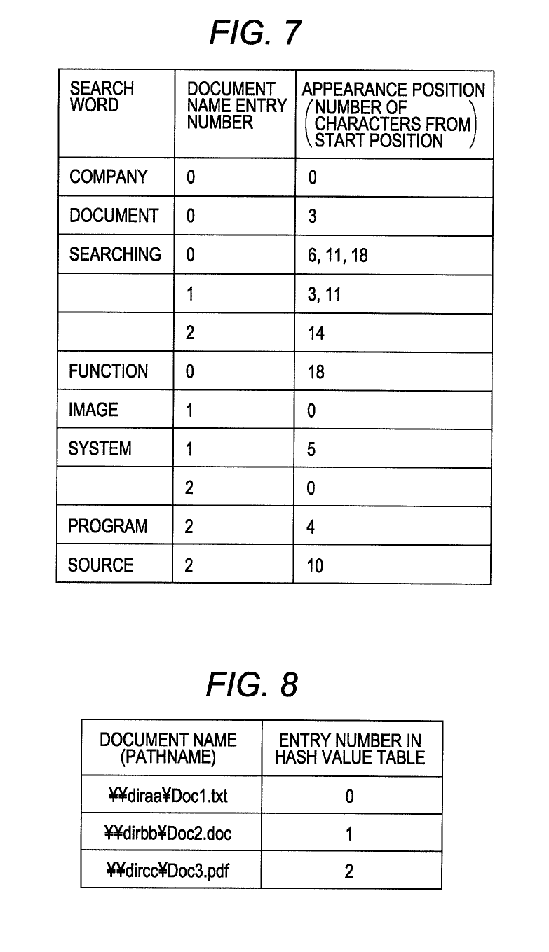

FIGS. 4A and 4B show data collection processing for index creation used for searching. In the data collection processing, a data file registered in the search target data DB 51 of the search target apparatus 50 is fetched and analyzed to retrieve keywords, which are registered in an index table as shown in FIG. 7 to generate a hash value used for comparison with an attached file. If necessary, the hash value is registered in the hash value table shown in FIG. 6 before the file pathname and an entry of the relevant document are mapped for registration in a pathname entry table as shown in FIG. 8.

In the first step S201 (FIG. 4A) of the data collection processing, the hierarchical structure is traced from a directory to be an origin in the search target data DB 51 of the search target apparatus 50 and pathnames of all data files are referenced and recorded in a work area. Then, the data collection processing references data of one file for each recorded pathname (S202) and does nothing if the file is a text file, and converts the file into a text file if the file is not a text file (S203, S204, and S205) before proceeding to S206.

In step S206 of the data collection processing, keywords are retrieved using a publicly known method such as morphological analysis and N-Gram before creating an index. The data collection processing is performed repeatedly till the last of pathnames recording processing of steps S202 to S206 (until the determination of S207 is Y).

When the determination of S207 is Y, the data collection processing performs processing of step S208 shown in FIG. 4B. In step S208 of the data collection processing, a hash value is determined for each file indicated by the recorded pathname. In step S209, the hash value table is searched based on the hash value.

In step S210, the data collection processing determines whether or not the current hash value is registered in the hash value table. If the hash value is not registered (S210: N), the data collection processing registers the current hash value in the hash value table as a new entry in step S211 before proceeding to step S212. If the hash value is registered (S210: Y), the data collection processing skips step S211 to proceed to step S212. Only the entry number and hash value are registered in step S211 and all fields of the attachment count continues to be “0”.

In step S212, the data collection processing registers the pathname of the relevant file and an entry of a record having a hash value matching that of the relevant file in the hash value table as one record in the pathname entry table shown in FIG. 8 by mapping them. By associating the pathname entry table and the hash value table by a common entry, a file attached to a mail and position information (pathname) of a file stored in the search target data DB 51 are mapped.

The data collection processing is performed repeatedly till the pathnames recording processing of steps S208 to S212 (until the determination of S213 is Y) is finished. When the last one is completed, the data collection processing terminates. An index as shown in FIG. 7 is thereby created for the data files in the search target data DB 51 and also a pathname entry table as shown in FIG. 8 is created. These tables show results of retrieving keywords by taking three data files shown in Table 1 as an example.

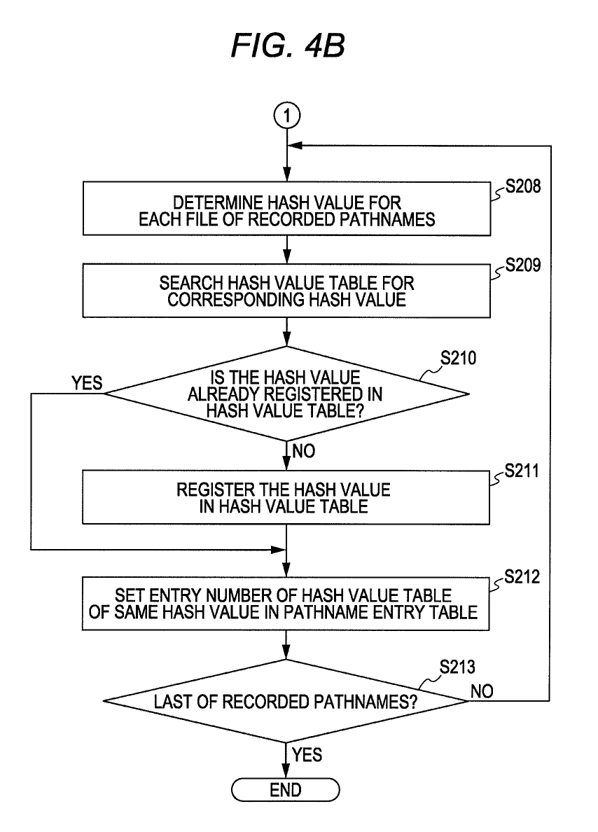

Next, processing when a search requesting user enters predetermined keywords as search conditions by operating the input/output apparatus 40 will be described based on a flowchart in FIG. 5.

When a search requesting user enters search keywords in the search keyword input unit 41 in the first step S301 of search processing, the search mechanism 81 accepts the search request in step S302 and extracts all entries corresponding to the search keywords by referring to the index DB 71. If, for example, the keyword is “search”, hits occur in three documents, as shown in FIG. 7.

Subsequently in step S304, the search processing causes the priority determination mechanism 82 to calculate scores of priority (ranking). At this point, it is determined whether or not the mail attachment counts for each period are recorded (step S305). If the mail attachment counts are recorded, scores are calculated by factoring in the mail attachment counts for each period (step S306).

Then, the search processing sorts search results according to scores of ranking in step S307 and causes the search result display unit 42 to display search results in step S308 before terminating the search processing.

Here, for example,

Score=number of times of keyword appearance in the relevant file×10+mail attachment count for each period×2 can be used as a score calculation method of priority. Since the attachment count is calculated by totaling the attachment count in three periods, as described above, the score of priority will change depending on the date on which a search is done.

Description will be given to an example of calculation of a score by the priority determination mechanism 82 based on attachment counts shown in FIG. 6 and numbers of times of appearance shown in FIG. 7. “Search” appears three times in the file of Entry 0, but the attachment count is “0” in every period and thus, the score will be 30 regardless of the period. “Search” appears two times in the file of Entry 1, and if calculated on the 5th, for example, the score will be “50” because the attachment count is “15”, but if calculated on the 30th, the score will be “20” because the attachment count is “0”. “Search” appears once in the file of Entry 2 and if calculated on the 5th, the score will be “20” because the attachment count is “5”, but if calculated on the 30th, the score will be “210” because the attachment count is “100”.

Therefore, priorities of the above concrete example will be as shown in Table 2. In Table 2, a higher field indicates a higher priority.

TABLE 2

| | Searched on 5th | | Searched on 30th | |
|---|---|---|---|---|
| Priority | Score | Pathname | Score | Pathname |
| High | 50 | ¥¥dirbb¥Doc2.doc | 210 | ¥¥dircc¥Doc3.pdf |
| Medium | 30 | ¥¥diraa¥Doc1.txt | 30 | ¥¥diraa¥Doc1.txt |
| Low | 20 | ¥¥dircc¥Doc3.pdf | 20 | ¥¥dirbb¥Doc2.doc |

What is claimed is:

1. A data search method which causes a computer to perform:
a search step of searching data stored in a search target apparatus based on keywords entered as search conditions;
a management step of detecting data attached as a file to an E-mail transmitted/received via a network in a predetermined zone and associating information identifying the attached file and an attachment count of the file being attached to E-mails before being recorded in a table for management; and
a priority determination step of, when a plurality of pieces of data matching the search conditions are extracted by the search step, determining a priority of each piece of extracted data by reading the attachment count of the extracted data attached to E-mails by referring to the table and reflecting the attachment count in the priority.

2. The data search method according to claim 1, wherein in the management step, data stored in the search target apparatus is converted by a hash function; a relevant hash value and an attachment count are recorded as a set of records in a hash value table; and when a file attached to an E-mail is detected, the attached file is converted by the hash function to determine a hash value and the hash value table is searched based on the determined hash value to increment the attachment count of the record whose hash value matches, and
in the priority determination step, when specific data is extracted by the search step, the record corresponding to the extracted data is identified in the hash value table and the attachment count corresponding to the relevant file is read.

3. The data search method according to claim 1 or 2, wherein in the management step, frequencies of data attached to E-mails are managed in segmented time sequence.

4. A computer apparatus readable recording medium recording a data search program which causes a computer apparatus to function as:
search means for searching data stored in a search target apparatus based on keywords entered as search conditions;
management means for detecting data attached as a file to an E-mail transmitted/received via a network in a predetermined zone and associating information identifying the attached file and an attachment count of the file being attached to E-mails before being recorded in a table for management; and
priority determination means for determining a priority of each piece of extracted data by reading the attachment count of the extracted data attached to E-mails by referring to the table and reflecting the attachment count in the priority when a plurality of pieces of data matching the search conditions are extracted by the search means.

5. The computer apparatus readable recording medium recording a data search program according to claim 4, wherein
the data search program causes
the management means to function so that data stored in the search target apparatus is converted by a hash function; a relevant hash value and an attachment count are recorded as a set of records in a hash value table; and when a file attached to a mail is detected, the attached file is converted by the hash function to determine a hash value and the hash value table is searched based on the determined hash value to increment the attachment count of the record whose hash value matches,
the data search program further causing the priority determination means to function so that when specific data is extracted by the search means, the record corresponding to the extracted data is identified in the hash value table and the attachment count corresponding to the relevant file is read.

6. The computer apparatus readable recording medium recording a data search program according to claim 4 or 5, wherein
the data search program causes
the management means to function so that frequencies of data attached to E-mails are managed in segmented time sequence.

7. A data search apparatus, comprising:
search means for searching data stored in a search target apparatus based on keywords entered as search conditions;
management means for detecting data attached as a file to an E-mail transmitted/received via a network in a predetermined zone and associating information identifying the attached file and an attachment count of the file being attached to E-mails before being recorded in a table for management; and
priority determination means for determining a priority of each piece of extracted data by reading the attachment count of the extracted data attached to E-mails by referring to the table and reflecting the attachment count in the priority when a plurality of pieces of data matching the search conditions are extracted by the search means.

8. The data search apparatus according to claim 7, wherein the management means converts data stored in the search target apparatus by a hash function; records a relevant hash value and an attachment count as a set of records in a hash value table; and when a file attached to an E-mail is detected, converts the attached file by the hash function to determine a hash value and searches the hash value table based on the determined hash value to increment the attachment count of the record whose hash value matches, and
when specific data is extracted by the search means, the priority determination means identifies the record corresponding to the extracted data in the hash value table and reads the attachment count corresponding to the relevant file.

9. The data search apparatus according to claim 7 or 8, wherein the management means manages frequencies of data attached to E-mails in segmented time sequence.
